(19) United States
(12) Patent Application Publication
(10) Pub. No.: US 2012/0001771 A1
(43) Pub. Date: Jan. 5, 2012

(54) COMPUTER BASED SYSTEM AND METHOD FOR PROVIDING A DRIVER ASSIST INFORMATION

(76) Inventors: Hans Roth, Karlsruhe (DE); Lee Bauer, Karlsruhe-Gruenwettersbach (DE)

(21) Appl. No.: 13/174,019

(22) Filed: Jun. 30, 2011

(30) Foreign Application Priority Data
Jul. 2, 2010 (EP) 10 168 245.8

(51) Int. Cl. G08G 1/09

(52) U.S. Cl. 340/905

(57) ABSTRACT

A computer based system for providing a driver assist information for a vehicle driver comprises a capturing device that captures an image, a recognition device that recognizes an object or a situation in the captured image, and a categorizing device that assigns a category of a predetermined set of categories to the recognized object or situation. The system also includes a status determining device of the vehicle that determines an operating status of the vehicle, and a driver assist device that automatically generates the driver assist information based on the determined operating status and the category.

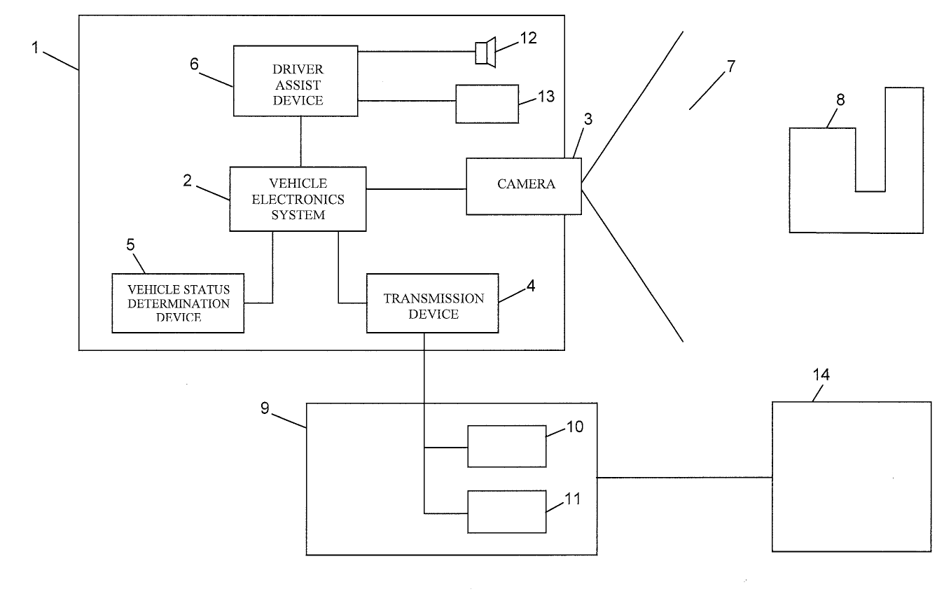

### 1. CLAIM OF PRIORITY

This patent application claims priority from EP Application No. 10 168 245.8 filed Jul. 2, 2010, which is hereby incorporated by reference.

### 2. FIELD OF TECHNOLOGY

The present invention relates to a computer based system for providing driver assist information to a driver of a vehicle, and to a method for providing the driver assist information.

### 3. RELATED ART

Many vehicles are equipped with sensors and a computer based system for sensing an environment of the vehicle and for providing driver assist information to the vehicle driver. For example, a park distance control system monitors an area in front and behind of the vehicle and provides the driver of the vehicle with assist information whether an obstacle is located in the monitored area. Furthermore, for example the vehicle may be equipped with a system for monitoring a section of the road in front of the vehicle to provide driver assist information concerning a distance to a vehicle driving in front of the vehicle or concerning an obstacle, for example an accident or a person in front of the vehicle.

Despite the development of the above described systems there still remains a need for providing an improved driver assist information comprising more detailed and more useful information to the driver during a drive or during an operation of the vehicle.

### SUMMARY OF THE INVENTION

According to an aspect of the present invention, a method for providing a driver assist information for a vehicle driver comprises capturing an image and automatically recognizing an object or a situation in the captured image. Then, a category of a predetermined set of categories is automatically assigned to the recognized object or situation. An operating status of the vehicle is determined and the driver assist information is automatically generated based on the determined operating status and the assigned category.

The image may be captured with a camera. The captured image may be of an environment outside the vehicle, for example in front of the vehicle, behind the vehicle or beside the vehicle, or capturing a view of an inside of the vehicle or a view of the driver of the vehicle. The predetermined set of categories may comprise categories of objects or situations commonly occurring in an environment or inside the vehicle during an operation of the vehicle. For example, the set of categories may comprise a generic obstacle or more detailed defined objects, for example a pole, a stone, a toy, a person, a child, a generic vehicle, a car, or a bicycle. In case the image comprises for example an environment behind the vehicle during the vehicle driving backwards, a more detailed information concerning an object behind the vehicle can be provided to the driver, for example by outputting the category to the driver indicating that a pole, a stone, a person, or a child is located behind the vehicle. Furthermore, the set of categories may comprise for example specific situations, for example an accident, a driver with closed eyes, or a generic dangerous situation, for example a deer crossing the road or a child playing at the curb of the road.

In combination with the operating status of the vehicle, an appropriate warning may be output to the driver of the vehicle as the driver assist information. For example, when the vehicle is moving and it is detected that the driver's eyes are closed, a wake-up function of the vehicle may be activated, for example a belt pretensioner, a bell, or a vibrating device at a steering wheel of the vehicle may be activated. In case an accident in front of the vehicle is determined, depending on the current speed of the vehicle and a current brake activity of the driver, a warning to reduce the speed may be output to the driver. Furthermore, an automatic brake assist system may slow down the vehicle appropriately. Furthermore, the set of categories may comprise for example a category defining an occupied seat in the vehicle. Depending on this category, an audio system of the vehicle may be set accordingly to provide the person occupying the seat in the vehicle with audio output from the vehicle audio system. Moreover, based on a view of an inside of the vehicle the category may indicate if a driver belongs to a group of authorized drivers that is defined for the vehicle. When the driver wants to start the vehicle, a security system of the vehicle determines if the driver belongs to the group of authorized drivers and allows starting the vehicle only if this test is passed successfully.

The generated driver assist information may be output to the driver of the vehicle as a speech message. Thus, for example during parking the vehicle, detailed information about an obstacle behind the vehicle can be provided acoustically to the driver, for example by warning the driver that a child or a stone is located behind the vehicle. Therefore, the driver can reduce his driving speed and focus his attention accordingly for driving more carefully when a child, which may move, is detected behind the vehicle.

The captured image may be transmitted to a server outside the vehicle and the category is received as a response from the server. As analyzing the captured image in real time may consume much more computing power than available inside the vehicle, this task may be performed outside the vehicle by a server. The server may be any kind of web server or portal located in a data communication network, for example the Internet, and may be accessible via a radio frequency transmission from the vehicle. The predetermined set of categories available in the server may be automatically adapted to latest categories implemented and available in the server. Therefore, providing a best possible driver assist information is maintained.

The operating status of the vehicle may comprise for example the vehicle driving forwards, the vehicle driving backwards, the vehicle changing a traffic lane, an operating status of an engine of the vehicle, a global position of the vehicle, or a driving speed of the vehicle.

According to another aspect of the present invention, a vehicle computer based system for providing driver assist information for a vehicle driver comprises an image capturing device for capturing an image, a recognition device for recognizing an object or a situation in the captured image, and a categorizing device for assigning a category of a predetermined set of categories to the recognized object or situation. The system comprises a status determining device for determining an operating status of the vehicle and the driver assist device which is adapted to generate the driver assist information based on the determined operating status and the category.

These and other objects, features and advantages of the present invention will become more apparent in light of the following detailed description of preferred embodiments thereof, as illustrated in the accompanying drawings.

### DESCRIPTION OF THE DRAWINGS

The FIGURE is a block diagram illustration of a computer based system for providing a driver assist information according to an embodiment of the present invention.

### DETAILED DESCRIPTION OF THE INVENTION

The FIGURE shows a vehicle 1 comprising a vehicle electronic system 2 connected to a capturing device 3, a transmission device 4, a vehicle status determination device 5, and a driver assist device 6. The capturing device 3 may comprise one or more cameras for capturing images of an environment inside and/or outside the vehicle. The capturing device 3 may capture for example images behind the vehicle, in front of the vehicle or beside the vehicle. The capturing device 3 may further comprise a camera for capturing images of an inside of the vehicle, for example of a driver sitting on a driver seat of the vehicle. Each capturing device 3 captures an image of an associated capturing area 7. The image captured by the capturing device 3 may comprise an object 8 or a situation within the capturing area 7.

Images captured by the capturing device 3 are passed via the vehicle electronic system 2 to the transmission device 4 and sent by the transmission device 4 to a server 9 outside the vehicle 1. The transmission between the transmission device 4 and the server 9 may comprise for example any wireless transmission, for example a UMTS, GPRS, or WLAN transmission. The server 9 may be any kind of server located in the internet or in a data communication network and may provide a portal or a website accessible by the transmission device 4. The server 9 may comprise a recognition device 10 for analyzing the image captured by the capturing device 3 and for recognizing the object 8 or the situation in the captured image. Furthermore, the server 9 comprises a categorizing device 11 receiving information of the recognized object or situation from the recognition device 10 for assigning a category to the recognized object or situation. The category is selected from a predetermined set of categories comprising for example objects like a pole, a stone, a toy, a person, a child, a car, a bicycle, or a vehicle, or situations like a driver with closed eyes, an occupied seat in the vehicle or a dangerous situation on a road. The assigned category is sent from the categorizing device 11 of the server 9 to the transmission device 4. In the vehicle 1, the category received by the transmission device 4 is forwarded by the vehicle electronic system 2 to the driver assist device 6. However, according to another embodiment, the processing performed of devices 10 and 11 may of course also be performed by the electronic system 2 of the vehicle if sufficient computing power and memory is available.

The vehicle status determining device 5 provides vehicle status information to the vehicle electronic system 2. The vehicle status information may comprise for example a driving direction of the vehicle, whether the vehicle is driving forwards or backwards or if the vehicle is changing a traffic lane, an operating status of the vehicle engine or whether the engine is running or not, a global position of the vehicle provided for example by a global positioning system (GPS), or a current driving speed of the vehicle. The operating status information received from the vehicle status determining device 5 is forwarded by the vehicle electronic system 2 to the driver assist device 6. The driver assist device 6 combines the vehicle status information and the category information and generates an appropriate driver assist information. The driver assist information may be output via a loudspeaker 12 or another warning device 13 of the vehicle 1 to assist the driver. Furthermore, the driver assist information is output by the driver assist determining device 6 to the vehicle electronic system 2 for directly controlling vehicle functions like a brake of the vehicle 1 or the engine of the vehicle 1 to assist the driver.

In the following, some examples of combining an operating status and a category in the driver assist device 6 for providing the driver assist information will be described in more detail.

When the driver is parking the vehicle 1 in a parking space and drives the vehicle backwards, the capturing device 3 mounted at a rear side of the vehicle 1 captures images from an area behind the vehicle. Images from the capturing device at the rear of the vehicle are transmitted to the server 9 and objects and situations behind the vehicle are recognized and categorized by the server 9. The category is transmitted back to the vehicle 1 and combined with the vehicle status indicating the vehicle driving backwards to a driver assistant information by the driver assistant device 6. When for example a child is playing behind the vehicle, the server 9 may determine a category like “child” or “playing child”. Therefore, the driver assist device 6 may output a warning via the loudspeaker 12 to the driver indicating that a child is located behind the vehicle. Furthermore, when the server 9 detects for example that a toy is lying in the capturing area 7, the driver assistant device 6 may output a warning indicating that a toy is present behind the vehicle to warn the driver that a child may come close to pick up the toy.

The capturing device 3 may capture a capturing area 7 inside the vehicle, especially an area where the driver is sitting. When the vehicle is not started (e.g., the engine of the vehicle is not running) the driver assist device 6 may verify with the help of the server 9 if a driver sitting on the driver seat belongs to a category of drivers currently authorized to use the vehicle. In case the driver does not belong to the category of authorized drivers, the driver assist device 6 may send a command to the vehicle electronic system 2 to inhibit starting the engine of the vehicle 1. In case the driver recognized on the vehicle seat is categorized as being a driver of a group of authorized drivers, the driver assist device 6 will provide an indication signal to the vehicle electronic system 2 allowing to start the engine of the vehicle 1. Furthermore, during movement of the vehicle as indicated by the vehicle status determining device 5, the driver assist device 6 may receive from the server 9 that the currently recognized driver on the driver seat is categorized as a driver having closed eyes. In this case, the driver assist device 6 may output a warning to wake up the driver. The warning may comprise for example an acoustic warning output by the loudspeaker 12 and/or may comprise activating a belt pretensioner of the safety belt of the driver seat to wake up the driver or activating a vibrating device at a steering wheel of the vehicle to wake up the driver.

The capturing device 3 may capture images of an inside of the vehicle 1 showing several or all seats of the vehicle 1. The server 9 may derive for each seat of the vehicle if a person is sitting on the seat or not. Based on this information, the driver assist device 6 may control for example an audio system of the vehicle to output audio information, such as music, in accordance with the detected seat occupation of the vehicle. If the driver is the only person present in the vehicle, the audio system may optimize the audio output for the driver only, whereas, when some more persons are present in the vehicle, the audio output of the audio system may be optimized to provide all the persons in the vehicle with audio information.

The capturing device 3 may capture images in a capturing area 7 in front of the vehicle. When the driver is driving the vehicle 1 along a road, the driver assist device 6 may provide a warning to the driver when an unusual situation occurs in front of the vehicle. The unusual situation may comprise for example a construction site or an accident in front of the vehicle 1. The server 9 may be adapted to analyze the images from the capturing device 3 to recognize and categorize such situations by comparing the captured image with a usual view of the capturing area 7 stored in the server 9. Usual views of areas stored in the server 9 may be retrieved with the help of a global position information of the vehicle provided by the vehicle status determining device 5 to the server 9. In case an unusual situation on the road in front of the vehicle is determined, the driver assist device 6 may output an audio warning to the driver of the vehicle and/or may activate a braking system of the vehicle and/or may reduce the speed of the vehicle by reducing the driving power of the engine of the vehicle.

The categorizing device 11 of the server 9 may be supported by a further service server 14 connected to the server 9. Furthermore, based on the category determined by the server 9, additional information may be retrieved by the server 9 from an additional service of server 14 relating to the determined category. For example, when a construction site is determined by the categorizing device 11, an additional information concerning the length of the construction site may be retrieved by the server 9 from the additional server 14 and provided as additional information to the driver assist device 6 to be output to the driver. Furthermore, as described in the example above, when a driver with closed eyes is determined by the categorizing device 11, a shortest route to a parking lot or a hotel may be retrieved by the server 9 from the server 14 and provided via the driver assist device 6 to the driver as a proposal for making a break.

It will be obvious to those reasonably skilled in the art that other components performing the same functions may be suitably substituted. Such modifications to the inventive concept are intended to be covered by the following claims.

What is claimed is:

1. A method for providing a driver assist information for a vehicle driver, the method comprising the steps of:
capturing an image;
automatically recognizing an object or a situation in the captured image;
automatically assigning a category of a predetermined set of categories to the recognized object or situation;
determining an operating status of the vehicle; and
automatically generating the driver assist information based on the determined operating status and the category.

2. The method according to claim 1, further comprising the steps of:
transmitting the captured image to a server outside the vehicle, and
receiving the category from the server.

3. The method according to claim 2, further comprising the step of outputting the generated driver assist information as a speech message to the driver of the vehicle.

4. The method according to claim 2, further comprising the step of outputting the generated driver assist information to a vehicle security system, the vehicle security system preventing the vehicle engine from starting in response to the determined operating status and the category.

5. The method according to clam 4, further comprising the step of outputting the generated driver assist information to a warning system.

6. The method according to claim 2, where the image comprises an image selected from the group comprising an environment outside the vehicle, an environment outside in front of the vehicle, an environment outside behind the vehicle, a view of an inside of the vehicle, and a view of a driver of the vehicle.

7. The method according to claim 2, where the predetermined set of categories comprises categories selected from the group comprising an obstacle, a pole, a stone, a toy, a person, a child, a car, a bicycle, a vehicle, an accident, a driver with closed eyes, a driver of a group of authorized drivers, an occupied seat in the vehicle, and a dangerous situation.

8. The method according to claim 6, where the operating status comprises an operating status selected from the group comprising the vehicle is driving forwards, the vehicle is driving backwards, the vehicle is changing a traffic lane, an operating status of a motor of the vehicle, a global position of the vehicle, and a driving speed of the vehicle.

9. A computer-based system for providing a driver assist information for a vehicle driver, the system comprising:
a device that captures an image;
a recognition device that recognizes an object or a situation in the captured image;
a categorizing device that assigns a category of a predetermined set of categories to the recognized object or situation;
a status determining device of the vehicle that determines an operating status of the vehicle; and
a driver assist device for automatically generating the driver assist information based on the determined operating status and the category.
